(19) United States
(12) Patent Application Publication
(10) Pub. No.: US 2003/0043499 A1
(43) Pub. Date: Mar. 6, 2003

(54) Disk drive with magnetic shield

(76) Inventors: Kazuhito Shimomura, Akishima-shi (JP); Masaru Atsumi, Ome-shi (JP)

Correspondence Address: PILLSBURY WINTHROP, LLP, P.O. BOX 10500, MCLEAN, VA, 22102, US

(21) Appl. No.: 10/230,998

(22) Filed: Aug. 30, 2002

(30) Foreign Application Priority Data
Aug. 31, 2001 (JP) 2001-264066

(51) Int. Cl. G11B 17/00

(52) U.S. Cl. 360/97.01

(57) ABSTRACT

A disk drive having a magnetic shield which can avoid effect of an external magnetic field is disclosed. The drive comprises a housing which contains a disk drive mechanism including a head and a disk medium. The housing has a structure wherein a tape-like or foil-like magnetic shield member is provided to shield an external magnetic field, in particular, in the vicinity of the head. The magnetic shield member is wound around the housing so as to cover each partial region of an upper surface facing a movement range of the head on the disk medium, lower surface and side surfaces.

### CROSS-REFERENCE TO RELATED APPLICATIONS

This application is based upon and claims the benefit of priority from the prior Japanese Patent Application No. 2001-264066, filed Aug. 31, 2001, the entire contents of which are incorporated herein by reference.

### BACKGROUND OF THE INVENTION

1. Field of the Invention

This invention relates to a field of disk storage, in particular to a disk drive with an improved magnetic shield effect.

2. Description of the Related Art

In recent years, in the field of disk storage represented by hard disk drives (hereinafter sometimes referred to as “disk drive”), it is promoted to improve a conventional longitudinal magnetic recording method and develop a perpendicular magnetic recording method, to achieve a high recording density.

Disk drives adopting the perpendicular magnetic recording method generally comprise a head disk assembly (HDA) using a single pole type head and a double-layered disk medium. In such disk drives, there is a phenomenon that the single pole type head focuses a disturbance magnetic field entering from the outside of the drives, and thereby data on a disk medium directly under a recording magnetic pole of the head is erased. Therefore, in particular, in disk drives adopting the perpendicular magnetic recording method, a technique concerning a magnetic shield for avoiding influence of a magnetic field from the outside is important.

As a prior art concerning a magnetic field of disk drives, a technique of shielding an external magnetic field of a drive and external or internal electromagnetic noises (for example, please refer to Jpn. Pat. Appln. KOKAI Pub. No. 6-236674). Further, a housing structure of a drive which can reduce a magnetic-flux density due to remanent magnetism inside the drive has been proposed (for example, please refer to Jpn. Pat. Appln. KOKAI Pub. No. 8-45261). Furthermore, there has been proposed a technique of preventing an external device from malfunctioning by reducing a leakage magnetic field of a voice coil motor (VCM) included in a HDA of a disk drive (for example, please refer to Jpn. Pat. Appln. KOKAI Pub. No. 4-301272).

However, these conventional arts are to be applied to disk drives adopting the conventional longitudinal magnetic recording method. Therefore, in the conventional arts, it has not been tested whether the techniques also produce magnetic shielding effects in disk drives adopting the perpendicular magnetic recording method using, in particular, a single pole type head. In a word, the conventional arts do not refer to a method of shielding an external magnetic field, which is effective for achieving a disk drive adopting the perpendicular magnetic recording method.

As described above, a disk drive adopting the perpendicular magnetic recording method has a structure wherein a single pole type head is used in combination with a double-layered disk medium. Therefore, the disk drive is in the state where an external magnetic field is liable to influence the disk medium via the head. Thus, a magnetic shield against an external magnetic field is necessary in particular in the vicinity of the head.

The following is a brief explanation of effect of an external magnetic field in a disk drive adopting the perpendicular magnetic recording method.

Specifically, in the drive, a magnetic flux from a main magnetic pole of the single pole type head passes through a recording layer of the double-layered disk medium, and reaches a soft magnetic layer provided under the recording layer. Thereby, a magnetic circuit is formed, which comprises the main magnetic pole of the single pole type head, the recording layer and the soft magnetic layer and a secondary magnetic pole of the single pole type head. The magnetic circuit records data in the recording layer of the disk medium.

If an external magnetic field is applied to the disk medium via the single pole type head, a similar magnetic circuit is formed, which causes a phenomenon that recorded data on the disk medium is erased.

To avoid such effect of an external magnetic field, there is a way of forming a disk drive main body of a housing of a magnetic material, or providing a magnetic shield member on the whole housing. However, such methods increase the weight and size of the drive main body, which is a factor preventing reduction in the weight and thickness of a disk drive.

### BRIEF SUMMARY OF THE INVENTION

The object of the present invention is to provide a disk drive with a magnetic shield which can effectively avoid effect of an external magnetic field, without preventing reduction in weight and thickness of a disk drive main body.

In accordance with one aspect of the present invention, there is provided a disk drive including a magnetic shield for avoiding effect of a magnetic disturbance in a head on a disk medium.

The disk drive comprises a housing which contains a disk drive mechanism including a disk medium and a head, and a magnetic shield member provided in a partial region of the housing facing a movement range of the head.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing an appearance of a disk drive according to a first embodiment of the present invention;

FIG. 2 is a diagram for explaining a structure of a drive mechanism concerning the embodiment;

FIG. 3 is a diagram for explaining an effect of a magnetic shield member concerning the embodiment;

FIG. 4 is a diagram showing a result of simulation for determining the width of the magnetic shield member concerning the embodiment;

FIGS. 5 and 6 are diagrams for explaining magnetic shield effect of a top cover concerning the embodiment;

FIG. 7 is a diagram for explaining a structure of a drive mechanism concerning a first modification of the embodiment;

FIG. 8 is a diagram for explaining a structure of a drive mechanism concerning a second modification of the embodiment;

FIG. 9 is a diagram for explaining a structure of a drive mechanism concerning a third modification of the embodiment;

FIG. 10 is a diagram for explaining a structure of a drive mechanism concerning a fourth modification of the embodiment;

FIG. 11 is a diagram for explaining a structure of a drive mechanism concerning a fifth modification of the embodiment;

FIG. 12 is a diagram for explaining effects concerning the embodiment and modifications;

FIG. 13 is a diagram for explaining a structure of a drive mechanism concerning a sixth modification of the embodiment;

FIGS. 14, 15 and 16 are diagrams for explaining a magnetic shield member concerning a seventh modification of the embodiment;

FIG. 17 is a diagram showing a structure of a disk drive concerning a second embodiment;

FIG. 18 is a diagram showing a main part of the disk drive concerning the second embodiment;

FIG. 19 is a diagram concerning a modification of the second embodiment;

FIGS. 20A and 20B are diagrams showing a structure of a disk drive concerning a third embodiment; and

FIG. 21 is a diagram showing a structure of a disk drive concerning a fourth embodiment.

### DETAILED DESCRIPTION OF THE INVENTION

Embodiments of the present invention will now be explained with reference to the drawings.

(First embodiment)

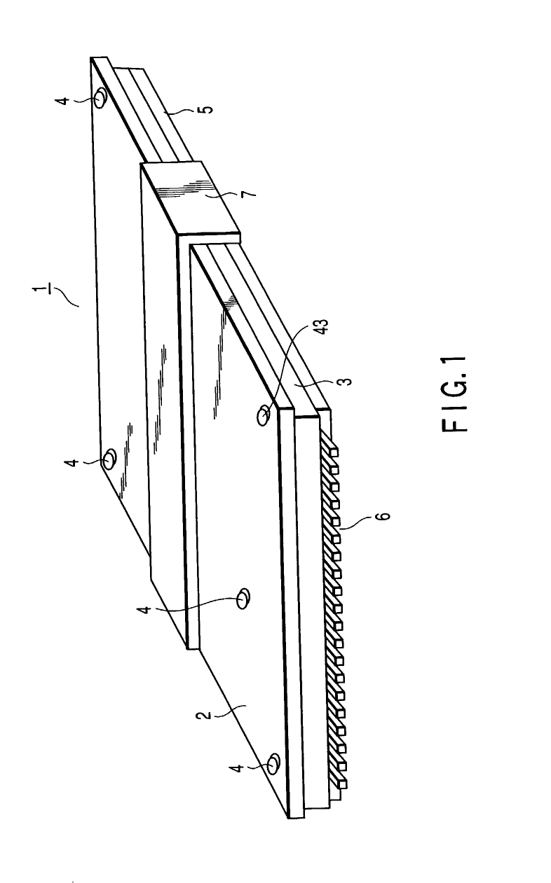

FIG. 1 is a diagram showing an appearance of a disk drive concerning this embodiment.

The disk drive is supposed to be a disk drive adopting a perpendicular magnetic recording method. The drive has a structure wherein a housing 1 contains a drive mechanism, such as a head disk assembly (HDA), and control circuits.

Further, as a magnetic head, the drive comprises a complex magnetic head in which a single pole type write head and a read head using a GMR (giant magnetoresistive) element are mounted on the same slider. Furthermore, the drive has a double-layered disk medium for perpendicular magnetic recording, as a disk medium.

As shown in FIG. 1, the housing 1 has a top cover 2 and a bottom base 3, which are fastened by screws 4. Further, a printed circuit board (PCB) 5 on which control circuits are mounted is fastened on the bottom base 3 by screws (not shown). The PCB 5 has an interface which performs data transmission and reception between an external system (host system) through a connector 6.

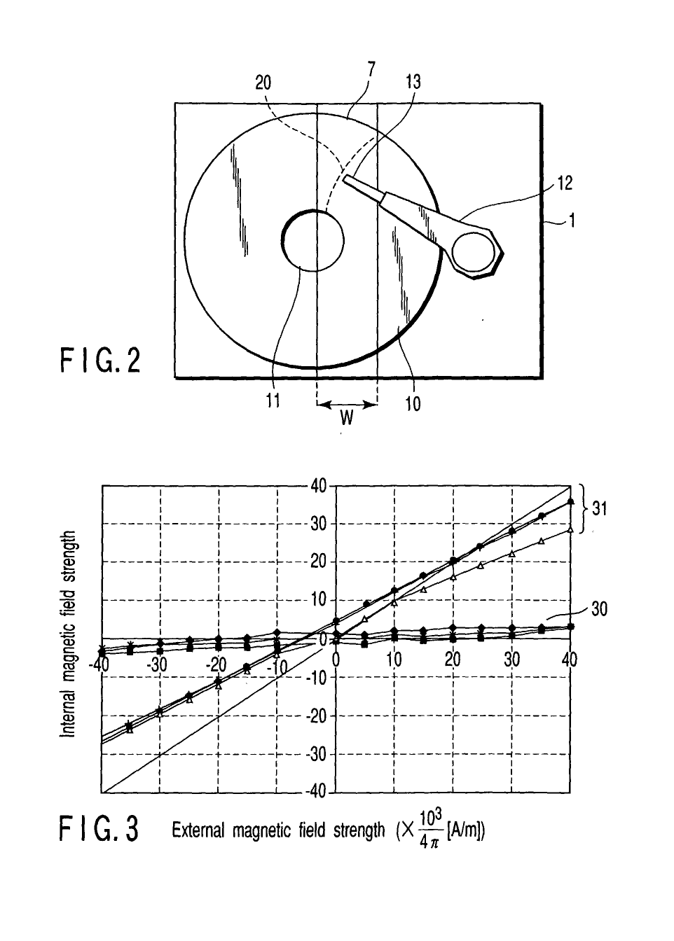

Further, in the embodiment, a tape-like or foil-like magnetic shield member 7 is provided to be wound around an upper surface, lower surface and side surfaces of the housing 1. The magnetic shield member 7 is formed of a magnetic material such as Permalloy (Registered Trademark), silicon steel material, or Amorphous Ribbon (product name of Strategy Humanity Technology, Inc. in the U. S. A.), which have a relatively high magnetic permeability (μ), or iron material (in particular, iron alloy material). The magnetic shield member 7 has a length enough to be wound around the upper surface, lower surface and side surfaces of the housing 1, and a width (W) enough to cover a movement range 20 of a magnetic head 13, as shown in FIG. 2.

The HDA comprises a disk medium 10 attached to a spindle motor 11, and the magnetic head 13 mounted on an actuator 12. As described above, the disk medium 10 is a double-layered disk medium for perpendicular magnetic recording, and is rotated by the spindle motor 11 at the time of driving the drive. Further, the magnetic head 13 is the above-mentioned complex magnetic head, and is structured to be radially movable on the disk medium 10 by a voice coil motor of the actuator 12 (movement range 20).

(Advantages of the Invention)

The magnetic shield member 7 of the embodiment enables inhibiting an external magnetic field of the housing 1. In particular, it is possible to effectively avoid effect of an external magnetic field with respect to the movement range 20 of the magnetic head 13 corresponding to the width (W) of the magnetic shield member 7. Therefore, it is possible to inhibit an external magnetic field from being applied to the double-layered disk medium 10 through the single pole type head, and thus consequently it is possible to prevent the phenomenon that recorded data on the disk medium 10 is erased.

Further, the magnetic shield member 7 in the embodiment is a tape-like or foil-like member, and provided only in a restricted range of the housing 1. Therefore, it can avoid the situation in which the size (in particular, the thickness) and the weight of the housing 1 are remarkably increased. Thus, it is possible to obtain an effective magnetic shield effect, and achieve reduction in size and weight, in particular in a disk drive of the perpendicular magnetic recording method.

The effects of the embodiment will now be specifically explained with reference to FIGS. 3 to 6.

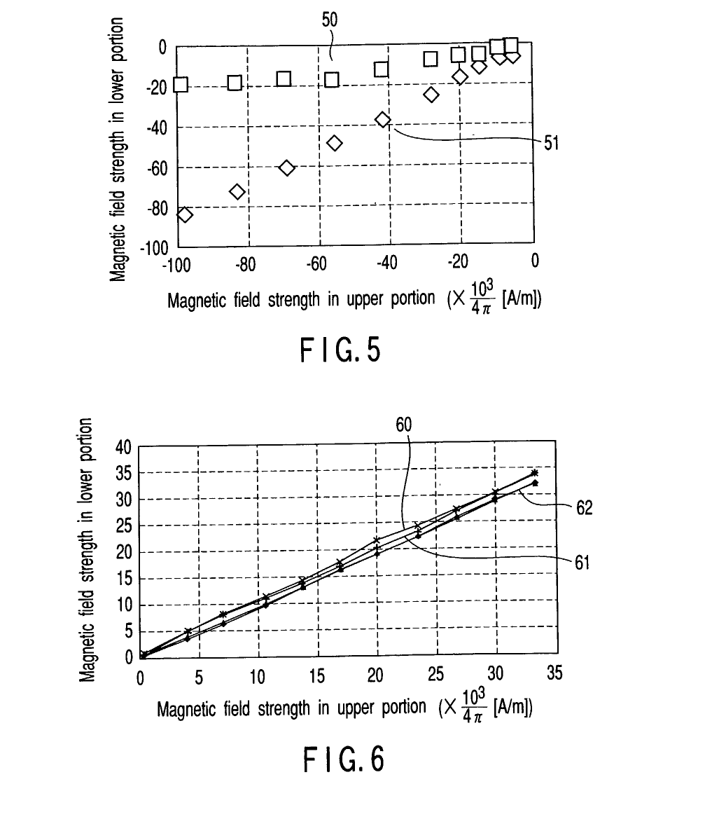

First, FIG. 5 is a diagram showing comparison of the magnetic field strength (minus direction) between the case where the top cover 2 of the housing 1 is an iron member being a magnetic material (50) and the case where the top cover 2 is an aluminum member being a non-magnetic material (51). The drawing shows the magnetic field strength in an upper portion and lower portion of the top cover 2 in the case where a static magnetic field (an external DC magnetic field) is applied from the upper portion of the top cover 2. The result of this comparison shows that an external magnetic field passes into the inside of the housing 1 in the case where the top cover 2 is made of a nonmagnetic material (51). Further, the result shows that the top cover 2 made of a magnetic material (50) has an excellent effect of shielding an external magnetic field.

In the meantime, FIG. 6 shows the magnetic field strength of the upper portion and lower portion of the top cover 2 in the case where the top cover 2 made of the iron material is inserted into an external uniform magnetic field, such as a magnetic field applied from a magnetic field generator using Helmholtz coils or the like. The measurement results 60-62 show the cases where the thickness of the top cover 2 is 0.1 to 0.5 mm. The results show that no magnetic shield effect can be obtained in all of the three cases. In short, in a disk drive using the top cover 2 made of a magnetic material such as an iron member, a magnetic shield effect shielding an external magnetic field can be obtained only in the case where an external magnetic field is applied only in one direction, that is, from the upper portion of the cover.

In comparison with this, as shown in FIG. 1, the embodiment has the structure wherein the magnetic shield member 7 is wound around not only the top cover 2 of the housing 1 but the bottom base 3 and the side surfaces. Specifically, the embodiment achieves an annular magnetic shield structure for the housing 1. The embodiment has a structure wherein an upper shield part (a shield member on the upper surface) and a lower shield part (a shield member on the lower surface) are connected on the side surfaces to form a path of a magnetic flux, and thereby the magnetic head 13 is located inside the annular shield member 17.

FIG. 3 is a diagram showing a comparison between a measurement result 30 in an annular shield structure of the embodiment, and a measurement result 31 in a planar shield structure. Further, both results are obtained with the thickness of the cover changed. As is clear from FIG. 3, the annular shield structure (30) in the embodiment is more excellent than the planar shield structure (31) in the effect of shielding an external magnetic field (magnetic shield effect).

Further, the magnetic shield structure of the embodiment covers a predetermined range by a restricted tape width (W) without covering the whole surface of the housing 1. Therefore, it is possible to reduce the material and manufacturing cost in comparison with the case of covering the whole surface of the housing 1.

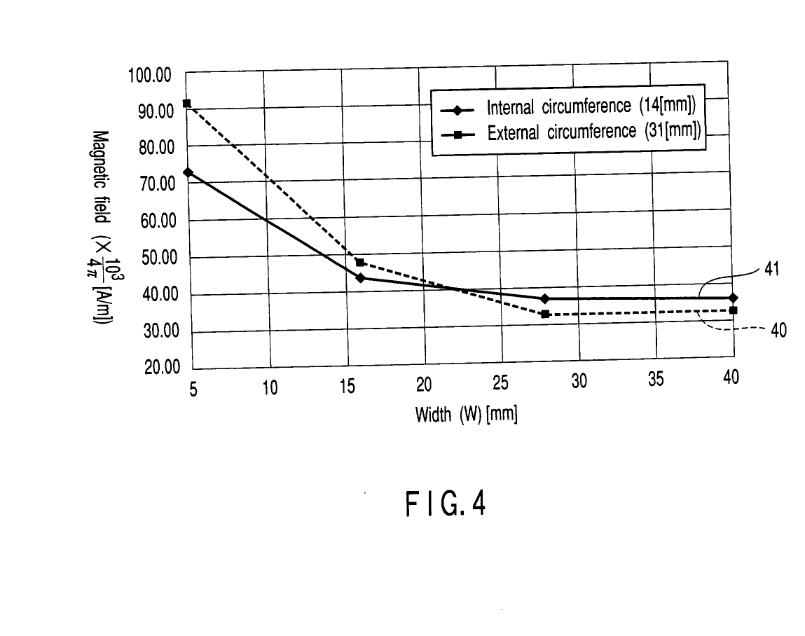

FIG. 4 shows a calculation result in a simulation concerning determination of the tape width (W) of the magnetic shield member 7 in the embodiment. This is obtained by calculating the magnetic field strength applied to the magnetic head 13, in the case where a uniform external magnetic field is applied by using a Helmholtz coils or the like used as an external magnetic field.

Specifically, the tape width (W) is calculated from parameters based on the state where the magnetic head 13 is located in the center of the disk medium 10. As the parameters, for example, the thickness of the tape is set to 0.4 mm, and the relative permeability is set to 1000. The calculation result shows that the magnetic shield effect is saturated in a too broad tape width and is redundant, although a greater magnetic shield effect can be expected in a relatively wider tape width (W).

In short, it has been confirmed that a width (W) which can cover a movement locus of the magnetic head 13 as shown in FIG. 2 is enough, and no effect is obtained by increasing the width from it. Specifically, a proper width (W) of the magnetic shield member 7 ranges from about 10 mm to 30 mm, not exceeding about 40 mm.

(Selection of the material of the magnetic shield member)

As described above, the magnetic shield member 7 in the embodiment is formed of a magnetic material having a relatively high magnetic permeability, such as Permalloy. A material having a high magnetic permeability has a character of being ready to collect magnetic fluxes, and thus has a large magnetic shield effect. However, since the embodiment has an annular shield structure in which the magnetic shield member 7 is wound around the upper surface, lower surface and side surfaces of the housing, magnetic fluxes of an external magnetic field concentrate on the side surfaces of the housing, which causes saturation magnetization.

Therefore, a material having not only a high magnetic permeability (μ) but also a high saturation flux density (Bs) is desirable as a magnetic material for the magnetic shield member 7. For example, a silicon steel material has a Bs of 2.0 or around.

Further, as a structure of inhibiting saturation magnetization on the side surfaces, it is effective to use a magnetic material for the side surfaces which is different from the magnetic material of the upper surface and the lower surface in the magnetic shield member 7. Specifically, a material having a relatively high magnetic permeability (μ) and a relatively low saturation flux density (Bs) is used as the magnetic material of the upper surface and the lower surface. In the meantime, a material having a relatively low magnetic permeability (μ) and a relatively high saturation flux density (Bs) is used as the magnetic material of the side surfaces. In other words, the magnetic shield member 7 has an annular shield structure made of a composite material.

Furthermore, it is possible to avoid saturation due to concentration of magnetic fluxes on the side surfaces, by setting the relation between the thickness (t1) of the shield member of the upper surface and the lower surface and the thickness (t2) of the shield member of the side surfaces to “t1<t2”. Therefore, a further increased magnetic shield effect can be obtained by forming the magnetic shields of the upper surface, the lower surface and the side surfaces so as to satisfy the above relation. In both the case where the material of the magnetic shield member for the upper and lower surfaces and that for the side surfaces are different from each other and the case where the materials are of the same kind, the members can be separate members and be joined together.

(Modification of the first embodiment)

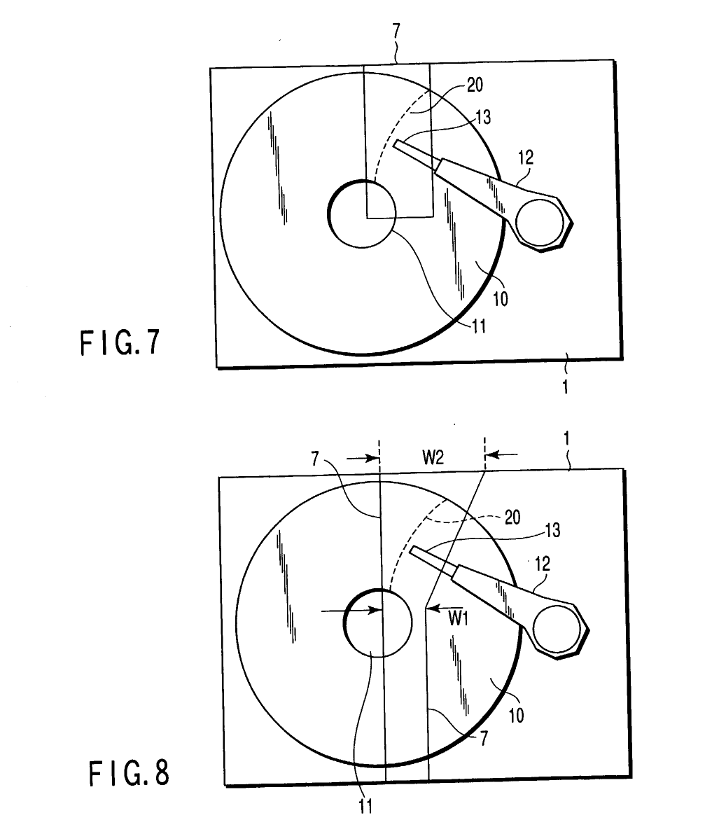

A modification of the embodiment will now be described with reference to FIGS. 7 to 16.

FIG. 7 is a diagram concerning a first modification. The modification has a structure wherein the magnetic shield member 7 is provided, in the upper surface (top cover 2) or the lower surface (bottom base 3) of the housing 1, only in a part facing the movement range (range corresponding to the movement locus) 20 of the magnetic head 13, and does not exist in the other parts.

Such a structure has an effect of reducing the material cost of the magnetic shield member 7, since a magnetic material is used only in the minimum part facing the movement range 20 of the magnetic head 13. However, also in this case, it is indispensable to provide the shield member for the side surfaces, which is within the range of the embodiment.

FIG. 8 is a diagram concerning a second modification. If the movement locus of the magnetic head 13 draws an arc in the first modification, it has been confirmed that, with the radial center of the disk medium 10 set as the base point, an external circumferential portion (40) and an internal circumferential portion (41) are different in the effect of shielding an external magnetic field (magnetic shield effect), as shown in FIG. 4.

The modification has a structure for reducing such a difference in the magnetic shield effect between the internal and external circumferential portions. Specifically, the modification has a structure wherein the width (W1) of the magnetic shield member 7 corresponding to the internal circumferential portion of the disk medium 10 is relatively narrowed, and the width (W2) thereof corresponding to the external circumferential portion is relatively broadened, as shown in FIG. 8. This structure enables adjustment of the magnetic shield effects in the internal and external circumferential portions such that they are almost equal to each other.

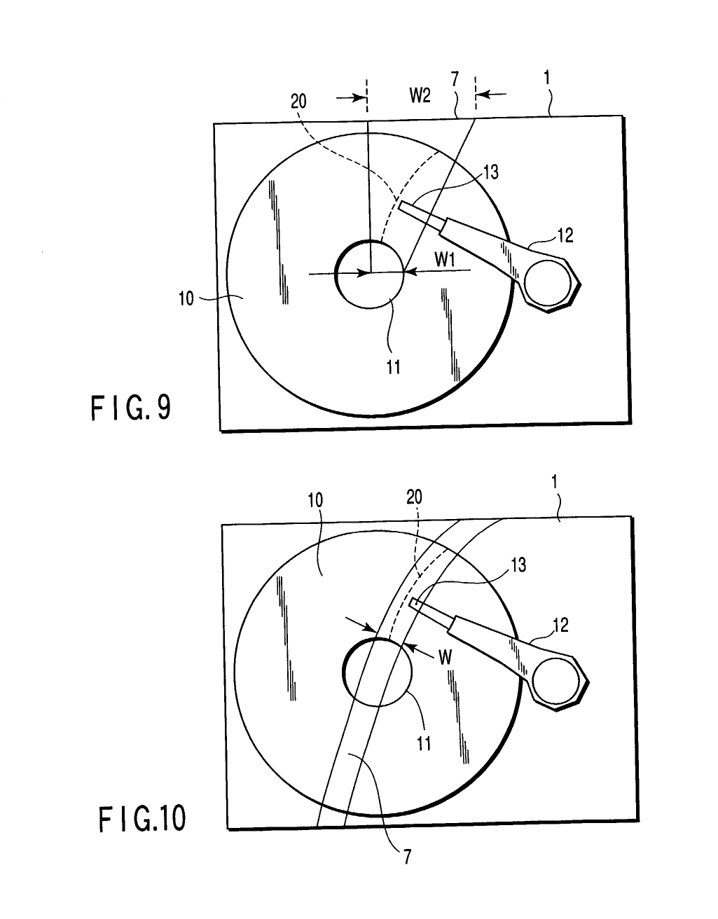

FIG. 9 is a diagram concerning a third modification. In short, the modification is obtained by combining the structures of the first and second modifications.

Specifically, in the modification, the magnetic shield member 7 is provided only in a part facing the movement range (range corresponding to the movement locus) 20 of the magnetic head 13, as shown in FIG. 9. Further, it has a structure wherein the width (W1) of the magnetic shield member 7 corresponding to the internal circumferential portion of the disk medium 10 is relatively narrowed, and the width (W2) thereof corresponding to the external circumferential portion is relatively broadened. Therefore, it has an effect of reducing the cost of the material of the magnetic shield member 7, since the magnetic material is used only in the minimum part facing the movement range 20 of the magnetic head 13. Further, this structure enables adjustment of the magnetic shield effects in the internal and external circumferential portions such that they are almost equal to each other.

FIG. 10 is a diagram concerning a fourth modification. The modification has a structure wherein the magnetic shield member 7 is provided on a part facing the movement range (range corresponding to the movement locus) 20 of the magnetic head 13, and also on a part facing a region extending along the locus.

In such a structure, it is possible to achieve an efficient magnetic shield for the movement range 20 of the magnetic head 13, and thus it is possible to relatively narrow the tape width (W) of the magnetic shield member 7. Therefore, it is possible to reduce the material cost of the magnetic shield member 7. Specifically, it is possible to narrow the tape width (W) by, for example, about 10 mm. However, the maximum value of a proper width (W) is about 40 mm.

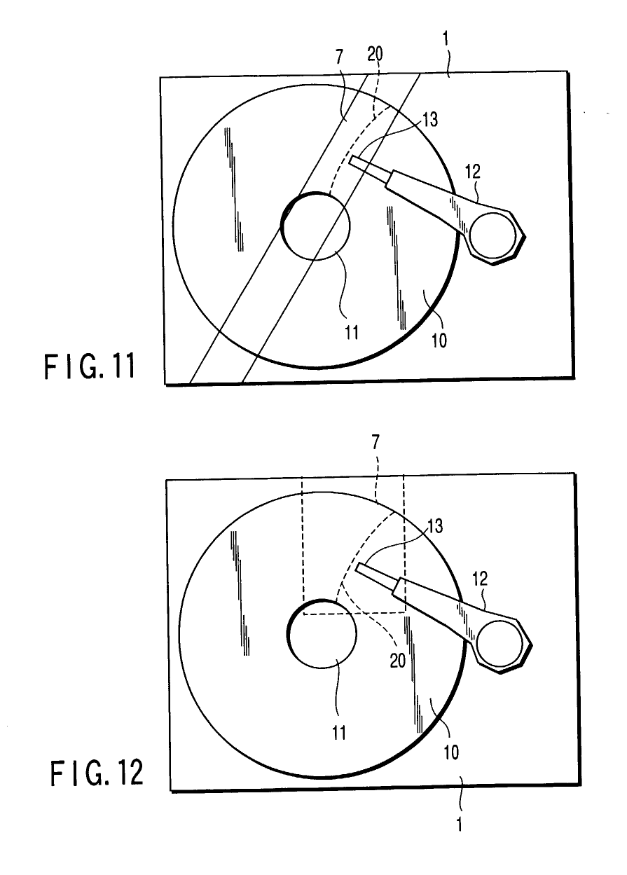

FIG. 11 is a diagram concerning a fifth modification. The modification is basically similar to the structure of the fourth embodiment. In the fourth embodiment, the magnetic shield member 7 is formed to have an arc shape in line with the movement range of the magnetic head 13. In comparison with this, in the fifth modification, the magnetic shield member 7 is formed to have a straight-line shape. The structure of the fifth modification can obtain an effect similar to that of the fourth embodiment.

In the embodiment and its modifications, the operation of providing the magnetic shield member 7 on the housing 1 is performed, at the last stage of the manufacturing process of the disk drives or at the time of shipping them from factories. The magnetic shield member 7 is attached to the outside of the housing 1, and thus it can be also used as a kind of a descriptive label which guarantees an external magnetic field shield of a disk drive shipped as a product.

Specifically, it means that an external magnetic field shield for the disk drive cannot be guaranteed in the state where a part of or the whole magnetic shield member 7 has been stripped from the housing 1, as shown in FIG. 12. In other words, it is considered as being effective when users diagnose failure. For example, if a disk drive which has been shipped as a product has broken down, based on the presence/absence of the magnetic shield 7, the user can diagnose whether the failure is caused by an external magnetic field or not.

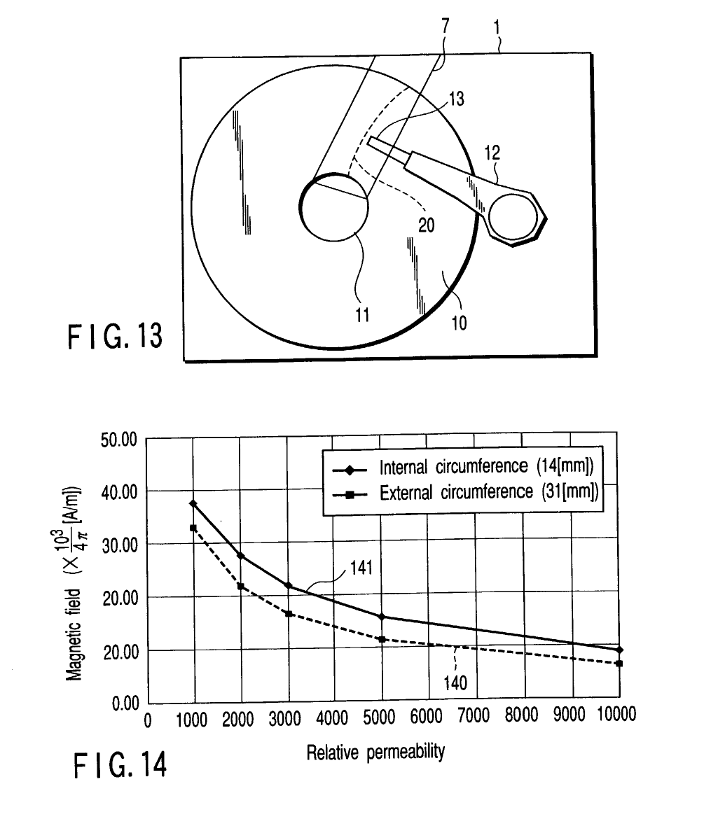

FIG. 13 is a diagram concerning a sixth modification. The modification has a structure wherein the magnetic shield member 7 having a straight-line shape is provided only on a part facing the movement range (range corresponding to the movement locus) 20 of the magnetic head 13.

FIGS. 14 to 16 are diagrams concerning a seventh modification relating to selection of the material of the magnetic shield member 7.

FIG. 14 is a diagram showing the result of examination of the relative permeability (μ), in particular. FIG. 14 shows the case where the tape thickness of the magnetic shield member 7 is about 0.4 mm, and the tape width (W) is about 28 mm. As shown in FIG. 14, it has been confirmed that generally the magnetic shield effect against an external magnetic field increases as the relative permeability (μ) becomes higher. Further, as described above, the external circumferential portion (140) and the internal circumferential portion (141) of the disk medium 10 differ in the shielding effect (magnetic shield effect) against the external magnetic field.

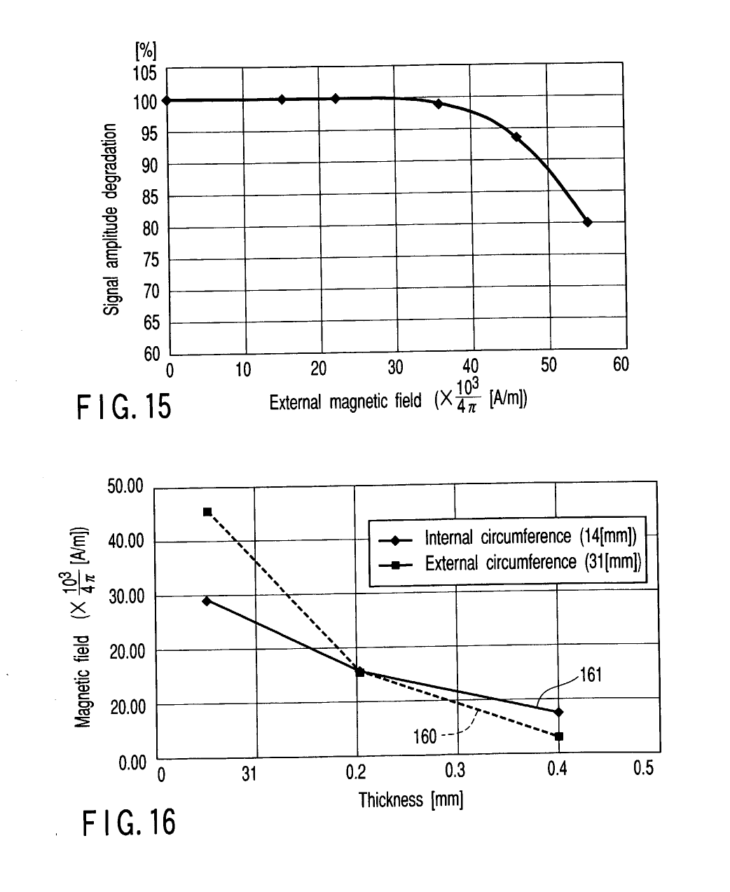

FIG. 15 is a diagram showing a degree of an external magnetic field by which the recorded data is erased, in particular on the disk medium 10 directly under the single pole type write head included in the magnetic head 13, in the case where no magnetic shield member 7 is provided. Specifically, FIG. 15 shows the degree of amplitude degradation from a reproduced signal from the disk medium 10 to the intensity of the external magnetic field.

From FIG. 15, it can be presumed that an external magnetic field has an enough effect on signal amplitude to degrade the signal amplitude to 95% or less, by which the recorded data on the disk medium 10 is erased. In view of such examination result and the examination result shown in FIG. 14, it is desirable to select a magnetic material having at least 1000 relative permeability (μ) as the material of the magnetic shield member 7.

FIG. 16 is a diagram showing the examination result concerning the tape thickness of the magnetic shield member 7. Specifically, FIG. 16 shows the degree of an external magnetic field to the tape thickness for each of the external circumferential portion (160) and the internal circumferential portion (161), in the case where the relative permeability (μ) is 1000 and the tape width (W) is about 28 mm.

FIG. 16 shows that generally magnetic shield effect against an external magnetic field increases as the thickness of the magnetic shield member 7 increases. However, it also shows that the magnetic shield effect is saturated at a certain thickness.

Further, the thickness of the magnetic shield member 7 can be a factor of preventing reduction in the thickness of the housing 1. Therefore, totally judging it as a disk drive by factors such as the magnetic field effect and reduction in the drive thickness, the thickness of the magnetic shield member 7 is preferably 0.1 mm to 0.4 mm. However, according to the magnetic characteristic of the shield material and the shield structure, it is preferably 0.05 mm to 0.4 mm.

(Second Embodiment)

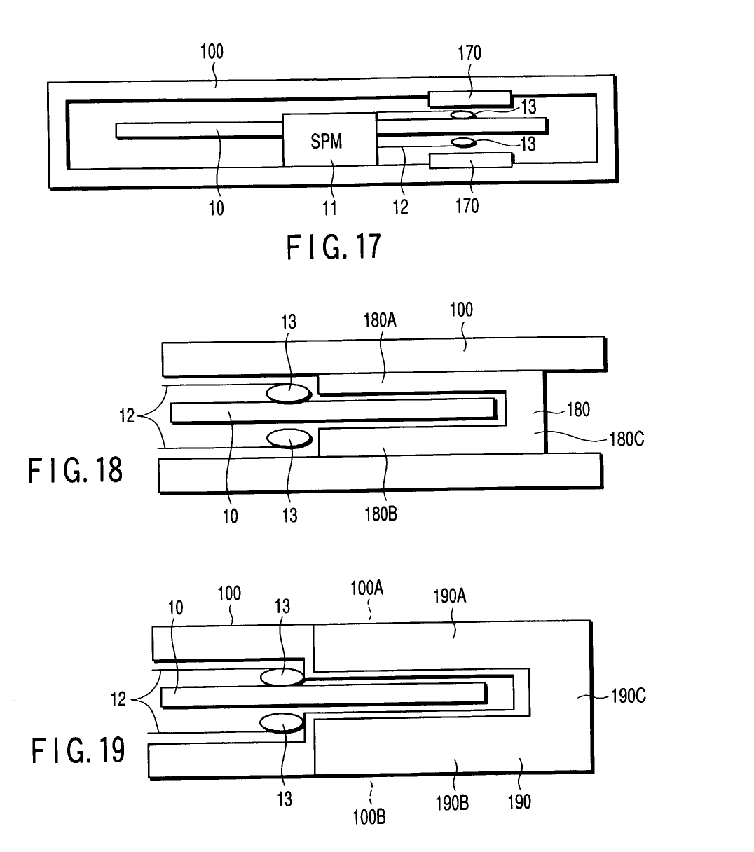

FIGS. 17 and 18 are diagrams concerning a second embodiment of the present invention. The embodiment has a structure wherein a magnetic shield member is disposed inside the housing 1 and in the vicinity of the disk medium 10 and the magnetic head 13, not outside the housing 1.

As shown in FIG. 17, the disk drive of the perpendicular magnetic recording method of the embodiment has a structure wherein a drive mechanism comprising a disk medium 10, spindle motor (SPM) 11 and a magnetic head 13, etc is contained inside a housing 100 made of a non-magnetic material such as an aluminum alloy. A disk drive having such a structure enables weight reduction in comparison with a drive using a housing made of an iron magnetic material or the like.

To obtain a magnetic shield effect against an external magnetic field, there is a way of providing a magnetic material 170 on each internal surface of the top cover and the bottom base facing the movement locus of the magnetic head 13, as shown in FIG. 17. However, this structure is effective only when a static magnetic field is applied from the top cover side or the bottom cover side, and cannot always obtain a good magnetic shield effect against an external magnetic field applied to the whole disk drive.

Further, to achieve reduction in the thickness, the space between each magnetic head 13 and the housing 100 is very limited. Therefore, if the magnetic material 170 is arranged in each of the spaces, it prevents reduction in the thickness of the drive, since a predetermined clearance must be secured between the magnetic material 170 and the magnetic head 13 in consideration of shock resistance of the material to the magnetic head 13.

Therefore, as shown in FIG. 18, the embodiment has a structure wherein a U-shaped magnetic shield member 180 is disposed on the disk medium 10, in the vicinity of the magnetic heads 13 but in a region other than a region facing an actuators 12 and the magnetic heads 13. The magnetic shield member 180 is made of a magnetic material having a relative permeability (μ) of at least 1000, such as an iron material and Permalloy.

Such a structure can reduce the effect of an external magnetic field applied to the vicinity of the magnetic heads 13, since the magnetic shield member 180 can effectively pass a magnetic flux applied to the vicinity of the magnetic heads 13 by the influence of an external magnetic field. Further, since the magnetic shield member 180 is not disposed on the movement range of each magnetic head 13, it is possible to secure a sufficient clearance, and to achieve reduction in the thickness of the housing 100. Such a structure can be called “offset shield structure”.

Further, the U-shaped magnetic shield member 180 in the embodiment has a structure wherein an upper shield portion 180A and a lower shield portion 180B are connected by a joint shield portion 180C. Therefore, it is possible to pass external magnetic fluxes applied to the upper and lower shield portions 180A and 180B to the joint shield portion 180C being a path of a low magnetic resistance. It is thus possible to obtain a good magnetic shield effect against an external magnetic field.

(Modification of the Second Embodiment)

FIG. 19 is a diagram concerning a modification of the second embodiment. The modification has a structure wherein a part 100A of a top cover corresponding to an upper surface of the housing 100 and a part 100B of the bottom base portion are formed to have a concave portion (offset portion), and a U-shaped magnetic shield member 190 is fitted into the concave portion.

The magnetic shield member 190 comprises an upper shield portion 190A disposed on the part 100A of the top cover, a lower portion 190B disposed on the part 100B of the bottom base portion, and a joint shield portion 190C which connects the upper and lower shield portions 190A and 190B and forms a part of a side surface of the housing 100. Such a structure can also obtain an advantageous effect similar to that of the second embodiment.

(Third Embodiment)

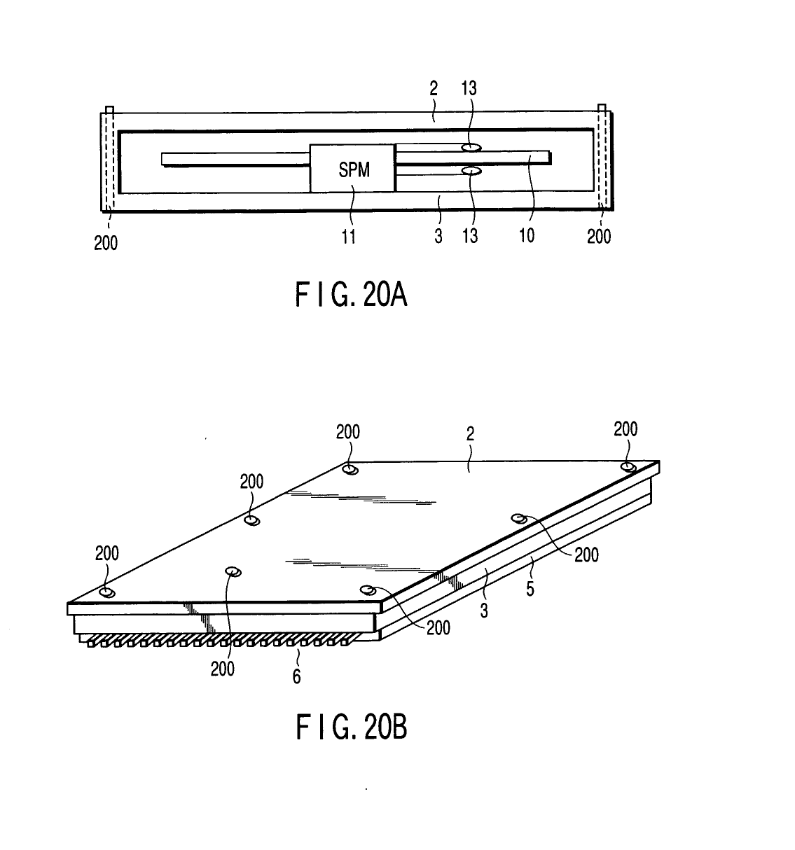

FIGS. 20A and 20B are diagrams concerning a third embodiment of the present invention.

As shown in FIG. 20A, the embodiments a disk drive having a structure wherein a drive mechanism comprising a disk medium 10, a spindle motor (SPM) 11 and magnetic heads 13 is contained inside a housing having a top cover 2 and a bottom base 3 which are made of an iron or Permalloy magnetic material, without using a particular magnetic shield member.

Further, as shown in FIG. 20B, the drive of the embodiment has a structure wherein the top cover 2 and the bottom base 3 are connected by screws 200 made of an iron magnetic material or a Permalloy magnetic material having a relatively high magnetic permeability.

In short, in the embodiment, the top cover 2 and the bottom base 3 correspond to an upper shield portion and a lower shield portion respectively, and the upper and lower shield portions are connected by the screws 200 corresponding to a side-surface shield portion. Therefore, the embodiment realizes a magnetic shield structure by a simple structure, without using a particular member such as a tape-like or foil-like magnetic shield member. Further, even if an external magnetic field has been applied from the upper or lower region of the disk drive, its structure can effectively produce a magnetic shield effect in, in particular, the vicinity of the magnetic heads 13, by passing the external magnetic flux to the shield portions. Therefore, if the magnetic shield structure of the embodiment is applied to a disk drive adopting the perpendicular magnetic recording method, it is possible to prevent the situation in which the recorded data on the disk medium 10 is erased due to influence of an external magnetic field.

(Fourth Embodiment)

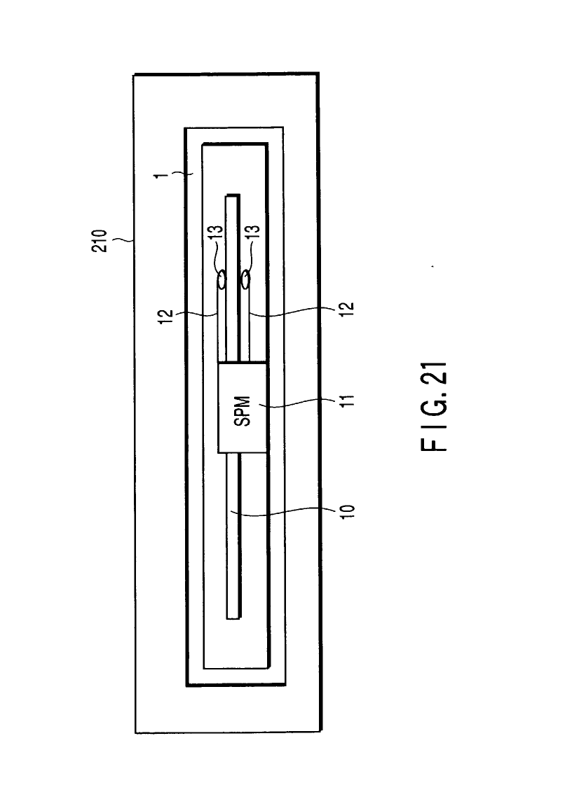

FIG. 21 is a diagram concerning a fourth embodiment of the present invention.

The embodiment has a structure wherein a disk drive in which a drive mechanism is contained in a housing 1 is further contained in a shield case 210 made of a magnetic material. In short, the embodiment is a disk drive having a full shield structure against an external magnetic field.

Such a structure can be applied to various uses, as well as both disk drives of the perpendicular magnetic recording method and longitudinal magnetic recording method to be mounted on personal computers. In particular, the structure is effective in disk drives used under the environment in which the disk is susceptible to an external magnetic field.

Specifically, it is effective in disk drives used for in-vehicle apparatuses such as navigation systems and audio visual apparatuses. Further, it is also effective in disk drives used for data storage of electric power apparatuses and power distribution apparatuses. In short, the disk drive with full shield structure of the embodiment is effective as a disk drive for systems and apparatuses which is required to completely shield external magnetic field and external noise and be highly reliable.

As described above, according to the embodiments and their modifications of the present invention, it is possible to provide a disk drive having a magnetic shield which can effectively avoid effect of an external field, without preventing reduction in weight and thickness of the disk drive main body. In particular, being applied to a disk drive of the perpendicular magnetic recording method, it can obtain an effective magnetic shield effect against an external magnetic field.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A disk drive comprising:
a housing which contains a disk drive mechanism including a disk medium and a head; and
a magnetic shield member provided in a partial region of the housing facing a movement range of the head.

2. A disk drive according to claim 1, wherein
the magnetic shield member is provided in plane regions of the housing facing the movement range of the head, and side surface regions connecting with the plane regions.

3. A disk drive according to claim 1, wherein
the magnetic shield member comprises a magnetic material having a size which covers a partial region of plane and side surfaces of the housing, and a partial region of the plane facing the movement range of the head.

4. A disk drive according to claim 1, wherein
the magnetic shield member is formed of a tape-like or foil-like magnetic material.

5. A disk drive according to claim 1, wherein
the magnetic shield member is formed of a magnetic material having, in the case of having a width of about 10 mm to 30 mm, a thickness ranging from about 0.2 mm to 0.4 mm and a magnetic permeability (μ) of at least 1000, or a thickness ranging from about 0.1 mm to 0.4 mm and a magnetic permeability (μ) of at least 3000.

6. A disk drive according to claim 1, wherein
the magnetic shield member has a size which covers a partial region of a plane of the housing facing the movement range of the head, and a width of the magnetic shield member in an external circumferential region of the disk medium is set to be wider than a width of the magnetic shield member in an internal circumferential region of the disk medium.

7. A disk drive according to claim 1, the disk drive adopting a perpendicular magnetic recording method, wherein
the disk medium is a double-layered disk of the perpendicular magnetic recording method, and the head is a magnetic head of the perpendicular magnetic recording method, the magnetic head having a single pole type head.

8. A disk drive comprising:
a housing which contains a disk drive mechanism having a magnetic disk and a plurality of magnetic heads opposed to respective surfaces of the magnetic heads;
a first magnetic shield member provided on each plane of the housing facing a movement range of each of the magnetic heads on the magnetic disk; and
a second magnetic shield member provided on each side surface of the housing and magnetically connected to the first magnetic shield member.

9. A disk drive according to claim 8, wherein
the first magnetic shield member and the second magnetic shield member are made of different magnetic materials.

10. A disk drive according to claim 8, wherein
a thickness of the second magnetic shield member is greater than a thickness of the first magnetic shield member, in the case where the first magnetic shield member and the second magnetic shield member are made of the same kind of magnetic material.

11. A disk drive according to claim 8, wherein
the first magnetic shield member and the second magnetic shield member are made of magnetic materials having different magnetic permeability.

12. A disk drive according to claim 8, wherein
the first and second magnetic shield members are formed of tape-like or foil-like magnetic material.

13. A disk drive according to claim 8, wherein
the first magnetic shield member is made of a magnetic material having a relatively high magnetic permeability and a relatively low saturation flux density,
the second magnetic shield member is made of a relatively low magnetic permeability and a relatively high saturation flux density, and
the first and second magnetic shield members having an annular magnetic shield structure wound around the housing.

14. A disk drive according to claim 8, the disk drive adopting a perpendicular magnetic recording method, wherein
the disk medium is a double-layered disk of the perpendicular magnetic recording method, and the head is a magnetic head of the perpendicular magnetic recording method, the magnetic head having a single pole type head.

15. A disk drive comprising:
a housing which contains a disk drive mechanism having a disk medium and a head; and
a magnetic shield member disposed inside the housing, the magnetic shield member being formed of plane magnetic shield members provided on an upper surface and lower surface of the housing except a movement range of the head, and a side magnetic shield member connecting the plane magnetic shield members.

16. A disk drive according to claim 15, wherein
the magnetic shield member is disposed outside the housing so as to be fitted into a concave portion provided in regions of the upper surface and the lower surface of the housing.

17. A disk drive according to claim 15, the disk drive adopting a perpendicular magnetic recording method, wherein
the disk medium is a double-layered disk of the perpendicular magnetic recording method, and
the head is formed of a plurality of magnetic heads opposed to respective surfaces of the magnetic disk.

18. A disk drive comprising:
a disk drive mechanism having a magnetic disk and a plurality of magnetic heads opposed to respective surfaces of the magnetic disk; and
a housing which contains the disk drive mechanism and has a magnetic shield structure formed by connecting an upper magnetic shield member forming an upper plane with a lower magnetic shield member forming a lower plane by screw members made of a magnetic material.

19. A disk drive according to claim 18, the disk drive adopting a perpendicular magnetic recording method, wherein
the magnetic disk and the magnetic heads have a structure of the perpendicular magnetic recording method.
